(19) United States
(12) Patent Application Publication
(10) Pub. No.: US 2026/0216880 A1
(43) Pub. Date: Jul. 30, 2026

(54) Calibration method for robotic equipment and system implementing the method

(71) Applicant: Starmatik Srl, Spresiano (TV) (IT)

(72) Inventor: Stefano Fava, Spresiano (TV) (IT)

(21) Appl. No.: 19/147,642

(22) PCT Filed: Jan. 24, 2024
(86) PCT No.: PCT/IB2024/050658

§ 371 Date: Jul. 11, 2025

(30) Foreign Application Priority Data
Jan. 31, 2023 (IT) 102023000001497

(51) Int. Cl. B25J 9/16

(52) U.S. Cl. CPC B25J 9/1692; B25J 9/1694

(57) ABSTRACT

A method for calibrating the components of robotic equipment includes positioning a laser pointer on a robot of the robotic equipment; determining the position of a zero point on the robot at the point where the laser sensor is positioned; positioning the robot so that the pointer can detect a plurality of points on a component the position and/or shape of which are/is to be acquired; determining a reference zero point of the component; determining the position of the zero point of the component with respect to the zero point of the robot, wherein the position is calculated by the robot. A system implementing the method is also disclosed.

The present patent concerns the methods for calibrating the components of robotic equipment and more specifically it concerns a new calibration method for robotic equipment and the system implementing the method.

Robotic systems are known which generally comprise machine tools equipped with moving parts, possibly a tool crib or other parts to be handled, such as pieces of equipment in general that must be recognized and arranged in the available space, and other ancillary components that are necessary for the complete machining and handling process.

The description provided here below refers to bending equipment by way of example only, but the concepts can however be extended to any other type of robotic equipment.

Bending systems include presses equipped with guides for the installation of tools. The tools, also called punches or dies depending on their function, are normally made up of substantially rectangular plates having a given thickness, wherein one edge of each plate is configured so that it can be positioned in the guides, while the opposite edge is shaped according to the machining operation to be performed.

Bending systems also comprise robots configured and programmed to grip and position tools or other components and to grip and handle the workpieces. Since the movement of the robots is fully automated, it is obvious that in order to guarantee the appropriate precision of the machining operations the exact position of all the components of the equipment must be known with high accuracy. For this purpose, it is necessary to perform calibration operations, which basically consist in acquiring all the zero points of all the components:

press, workpiece loading position, position of the aligner and any loading pallets, unloading and palletizing position of the machined pieces, position of the crib containing tools, members and various equipment, as well as position of all the tools and members inside the crib.

Said acquisition is currently carried out manually by one or more operators who face the following drawbacks: there is a large number of points to be acquired since, for example, the tools alone can be more than 300; the parts whose position must be acquired can be heavy and greasy with oil, and may also require the operator to assume rather uncomfortable and even inadvisable positions. For this reason, the calibration work can even take several days, resulting in operational costs and machine downtime.

Furthermore, the positive outcome of the acquisition process depends on the accuracy and dexterity of the operator. For this reason, data is often not exactly uniform for different systems or for the same systems calibrated by different operators or operators working at different times and under different conditions.

In order to solve the aforementioned drawbacks, a new method for calibrating the components of robotic equipment and a system implementing said method were designed and carried out.

The main object of the present invention is to provide a method for carrying out the calibration process while minimizing human intervention. Another object of the present invention is to ensure uniform calibration throughout the equipment.

Another important object of the invention is to reduce the time needed to complete the calibration process. For example, calibration can be performed at night, or it can be carried out while the operator is performing other tasks, for example preparing simulations for subsequent operating steps, thus optimizing time, or it can be performed remotely by means of a remote control.

An important advantage of the new calibration method lies in that the operation can be completely performed autonomously, which also guarantees safety for all operators.

Another object of the invention is to make it possible to apply the new system implementing the method even to existing equipment or to move it to other pieces of equipment or operating areas.

In addition, the new method and the corresponding system can be reused in the same piece of equipment if it needs to be recalibrated or if components have been added to and/or removed from the equipment, for example in the case of reconditioning and/or upgrading and/or modification of existing equipment, which therefore needs to be reconfigured and recalibrated.

These and other direct and complementary objects are achieved by the new method for calibrating the components of robotic equipment and by the system implementing the method.

The calibration system comprises at least one laser triangulation sensor, hereinafter also referred to as a laser pointer, which is intended to be installed on a robot forming part of the equipment, for example on a robot axis or in the gripping and positioning device designed to grip and position the tools or other elements.

A computer is in communication with said robot. The data transmitted between the computer and the robot may include commands to perform certain operations and/or data related to positions and distances measured during the execution process.

A calculation algorithm processes the collected data, obtaining the shape and position of the actual device that was subjected to the acquisition procedure.

The method comprises the following steps:
determining a zero point on said robot, for example on the gripping and positioning device, in any case at the point where said laser sensor is positioned;
positioning the robot in such a way that said sensor can detect a plurality of points on a component whose position is to be acquired;
determining the position of each of said points in relation to said zero point of the robot;
transmitting the positions of said detected points to said central computer;
determining a reference zero point of said component, calculated by said central computer: said zero point can be determined, for example, based on other points of the component; for example, if the component is a tool for bending equipment, the sensor determines the position of reference elements, such as holes, seats or machined gripping parts created on the tool, by detecting their contour points; once the position of said reference elements has been determined, the reference zero point of the component is determined in relation to said reference elements;
transmitting the position of said reference zero point of the component to the robot;
determining the position of said zero point of the component with respect to said zero point of the robot, wherein said position is calculated by the robot itself;
saving said position in the memory of the robot;
repeating the steps described above for other components.

As a result, the robot learns the position of all the components in relation to said zero point on the robot itself.

Before the steps described above, it is also advisable to perform the calibration of said laser pointer, that is, to determine the position of the laser pointer on the robot. This operation is necessary in order for the robot to know the exact position and orientation of the laser pointer, so that accuracy in the subsequent determination of the reference points on the components is guaranteed.

Said preliminary laser pointer calibration procedure includes the following steps:
fixing said laser pointer to the robot, for example to the positioning and gripping device of the robot; entering the data related to the theoretical position of the laser pointer on the robot;
positioning a calibration tablet, whose dimensional characteristics and zero point are known and which thus serves as a gauge;
positioning the robot in front of the tablet and performing a series of aimings at different positions of the robot on the six axes, that is, at different coordinates in the Cartesian coordinate system and at different rotation angles with respect to the three axes; each position of the robot is associated with the read depth value, which corresponds to the distance between said reference tablet and said zero point of the laser pointer mounted on the robot;
running a mathematical algorithm to determine the deviation between the expected theoretical position of the laser pointer on the robot and the actual position of the laser pointer on the robot. This algorithm is based on the principle of optimizing the parameters that define the position of the laser pointer with respect to the ‘end effector’, the arm or gripping member of the robot where the pointer is mounted: the more precise and corresponding to reality these parameters are, the smaller the approximation error of the point defined on the basis of the acquisitions made on the reference tablet.

With these operations, it will thus be possible to determine the position of the laser pointer on the robot with a high degree of accuracy and then proceed to the subsequent operations intended to determine the position of the other components of the equipment.

In the preferred solution, the robot to which this method is applied is an anthropomorphic robot with 6 or more axes, and more preferably an anthropomorphic robot with 7 axes, and said laser pointer is mounted on one axis of said robot.

The method described herein is used to calibrate the entire piece of equipment, regardless of the type of equipment or the number of components. It is therefore also possible to calibrate tools, storing their geometrical shape and their position, even inside the crib, and thus managing three-dimensional shapes.

Therefore, with reference to the above description, the following claims are made.

The invention claimed is:

1. A method for calibrating components of robotic equipment, comprising the steps of:
positioning a laser pointer on a robot in the robotic equipment, wherein said robot is an anthropomorphic robot with six or more axes;
determining a position of a zero point on said robot at a point where said laser pointer is positioned;
storing said zero point position in a central computer; positioning the robot so that said laser pointer can detect a plurality of points on a component whose position and/or shape are/is to be acquired;
determining the position of each of said plurality of points in relation to said zero point of the robot;
transmitting the positions of said detected points of the component to said central computer;
determining a reference zero point of said component, calculated by said central computer;
transmitting a position of said reference zero point of the component to the robot;
determining the position of said reference zero point of the component with respect to said zero point of the robot, wherein said position is calculated by the robot, and
saving said position of said reference zero point of the component in a memory of the robot.

2. The method according to claim 1, wherein said steps are repeated for each component of the robotic equipment.

3. The method according to, claim 1, wherein said component is a tool for bending presses or other element to be handled, wherein said laser pointer determines a position of one or more elements configured to grip and handle said component, and wherein said one or more elements comprise: one or more holes, recesses, or devices applied to said component.

4. The method according to, claim 1, further comprising a preliminary step of determining an actual position of said laser pointer on said robot, wherein said preliminary step comprises,
after positioning the laser pointer on the robot in the robotic equipment:
inputting a data related to a theoretical position of the laser pointer on the robot;
positioning a calibration tablet, whose dimensional characteristics and zero point are known;
positioning the robot in front of said tablet and performing a series of aimings at different positions of the robot on the six or more axes, at different coordinates in a Cartesian coordinate system and at different rotation angles with respect to three axes of the Cartesian coordinate system, so as to provide a depth value providing a value of a distance between the calibration tablet and the laser pointer, for each position of the robot; and
running a mathematical algorithm to determine a deviation between an expected theoretical position of the laser pointer on the robot and an actual position of the laser pointer on the robot.

5. A system for implementing the method according to claim 1, the system comprising a laser pointer mounted on a robot.

6. The system according to claim 5, wherein said laser pointer is mounted on a robotic arm, on a gripping and positioning device for tools, or other another device of said robot.

7. The system according to claim 5, wherein said laser pointer is mounted on an axis of said robot.

8. The system according to claim 5, wherein said robot is an anthropomorphic robot with 6 or more axes.
